(19) United States
(12) Patent Application Publication
(10) Pub. No.: US 2007/0273269 A1
(43) Pub. Date: Nov. 29, 2007

(54) Image display device

(76) Inventors: Yuichi Sukigara, Mobara (JP); Kazuo Sunahara, Mobara (JP); Yuuichi Kijima, Chosei (JP)

Correspondence Address: MILBANK, TWEED, HADLEY & MCCLOY, 1 CHASE MANHATTAN PLAZA, NEW YORK, NY, 10005-1413, US

(21) Appl. No.: 11/724,620

(22) Filed: Mar. 15, 2007

(30) Foreign Application Priority Data
Mar. 17, 2006 (JP) 2006-075086

(51) Int. Cl. H01J 63/04

(52) U.S. Cl. 313/496

(57) ABSTRACT

A display panel has an evacuation port at one side thereof, and the opening area of the evacuation port increases toward the periphery of the display panel. The display panel also has a frame member in the opening, and the height of the frame member lowers toward the inside of the display panel. According to the invention, by improving the evacuation efficiency in the airtight container and improving the vacuum level in the display panel in a short period of time, the electron emission characteristic is stabilized and the lifetime thereof is increased, allowing a high-quality, reliable image display to be provided.

### BACKGROUND OF THE INVENTION

1. Field of the Invention

The present invention relates to a flat-panel image display using electron emission into a vacuum formed between a front substrate and a rear substrate, and particularly to an image display in which a display panel formed of a front substrate and a rear substrate with a frame therebetween has an evacuation structure.

2. Description of the Related Art

As a display device that excels in luminance and resolution, a color cathode ray tube has been widely known. However, as high-resolution image processing apparatus and television broadcasting have been recently introduced, there is an increasing need for a lightweight, compact flat panel display (FPD) characterized by high luminance and high resolution.

As typical examples of the above-mentioned image display, liquid crystal displays and plasma displays have been commercialized. Particularly, there have been various types of commercialized flat-panel image displays, such as so-called electron emission image displays or field emission image displays as high-luminance, self-luminous displays using electron emission from electron sources to a vacuum space as well as organic electroluminescent displays characterized by low power consumption.

Among the flat-panel image displays, there have been known self-luminous flat panel displays configured in such a way that electron sources are arranged in a matrix. One of known such displays is the above-mentioned electron emission image display using miniaturized, integrated cold cathodes.

Examples of the cold cathodes used in self-luminous flat panel displays (FPDs) are thin film electron sources, such as the Spindt type, surface conduction type, carbon nanotube type, MIM (Metal-Insulator-Metal) type in which metal, insulator and metal are laminated, MIS (Metal-Insulator-Semiconductor) type in which metal, insulator and semiconductor are laminated, and metal-insulator-semiconductor-metal type.

There is a known structure of the MIM-type electron source disclosed in JP-A-8-180819. A known example of the Metal-Insulator-Semiconductor-type electron source is a MOS type electron source, and known examples of the Metal-Insulator-Semiconductor-Metal-type electron source are a HEED-type electron source, an electroluminescence-type electron source and a porous silicon-type electron source.

A known self-luminous flat panel display (FPD) has a display panel configured such that a rear substrate having any of the above-mentioned electron sources faces a front substrate having a phosphor layer and an anode that forms an accelerating voltage for directing electrons emitted from the electron sources to the phosphor layer, and an encapsulation frame encapsulates the inner space between the substrates facing each other and maintains the inner space in a predetermined vacuum state. Drive circuits are combined with the display panel for operation.

In an image display having MIM electron sources, the rear substrate is made of insulating material. On the substrate are formed a plurality of scan signal electrodes that extend in one direction and are juxtaposed in another direction perpendicular to the one direction, and scan signals are successively applied to the plurality of scan signal electrodes in the other direction. On the substrate are also formed a plurality of image signal electrodes that extend in the other direction and are juxtaposed in the one direction such that the image signal electrodes cross the scan signal electrodes. The electron sources are provided at intersections of the scan signal electrodes and the image signal electrodes. Both the electrodes are connected to the electron sources via feeding electrodes and current is supplied to each of the electron sources.

Each of the electron sources makes a pair with the corresponding phosphor layer to form a unit pixel. Three color unit pixels of red (R), green (G) and blue (B) typically form one pixel (color pixel). In a color pixel, unit pixels that form each color are also called sub-pixels.

In the thus configured flat panel image display (hereinafter also referred to as FPD), in general, a plurality of gap retention members (hereinafter also referred to as spacers) are disposed in a fixed manner in the airtight space surrounded by the rear substrate, the front substrate and the frame (also referred to as a support) so as to retain a predetermined gap between both substrates in cooperation with the frame. The frame is generally formed of a plate-like member or a formed member made of insulating material, such as glass and ceramic, and disposed at the periphery outside the display area of the display panel.

In the thus configured FPD, the inside of the airtight container (vacuum container) formed of the surrounding rear substrate, front substrate and frame is maintained at a predetermined high vacuum level. As evacuation means for evacuating the airtight container, for example, JP-A-8-180819 discloses an image display having evacuation ducts provided across at least one side surface of the frame.

In another FPD, the display panel is formed by drilling a pair of through holes at diagonal corners of the rear substrate that forms the enclosure, joining the through holes with evacuation ducts in an airtight manner such that the through holes communicate with the evacuation ducts, evacuating the gas in the enclosure and chipping off the tips of the evacuation ducts.

### SUMMARY OF THE INVENTION

In conventional displays, although the time required for evacuation can be reduced, no consideration has been made to how to seal the evacuation ducts and the shape of the sealed portion. Only fixing and sealing the evacuation ducts on the side surface of one side of the panel may leave a possibility of deformation of the panel due to the external pressure because no frame is present at the side where the evacuation ducts are disposed.

In an FPD of this type, since the gap between the substrates are set to as small as about 3 mm, evacuation of the gas discharged from a bonding member for fixing the spacers will likely be insufficient. This is one of the factors that cause difficulty in retaining a high vacuum level. The residual gas disadvantageously prevents increase in lifetime of the panel.

In an FPD of this type, during heating, depressurizing and sealing in the sealing process, or during evacuation in the evacuation process, the evacuation of the display panel will be insufficient, so that the display panel cannot be uniformly evacuated to a high vacuum level. To eliminate this problem, the number of the evacuation ducts is increased to improve the entire vacuum level. Furthermore, insufficient evacuation of the display panel disadvantageously causes degradation of the electron emission characteristic of the electron source due to gas contamination. In particular, the gas remaining between the spacers in the display panel unlikely flows out of the display panel, so that the vacuum level is high only around the evacuation ports.

In the configuration in which a plurality of evacuation ducts are disposed on the rear side of the rear substrate, thermal expansion caused when the vacuum container is heated generates relative positional shifts among the plurality of evacuation ducts (shift of about 5 mm for a 32-inch panel). Such positional shifts are difficult to be handled by the evacuation head of the evacuation chamber connected to the tips of the evacuation ducts, resulting in a cause of failure, such as cracks in the evacuation ducts. Furthermore, part of the evacuation ducts remains as projections after the tips of the evacuation ducts are chipped off, which disadvantageously prevents reduction in thickness of the display panel.

Moreover, evacuation ports connected to the plurality of evacuation ducts present on the rear substrate pose a problem that, for example, water splash generated by cleaning water removal in a photo-etching process for forming various electrode wiring lines on the rear substrate likely causes electrode film failure.

Therefore, the invention has been made to solve the above-described conventional problems. According to the invention, evacuation efficiency in the airtight container can be improved and the vacuum level can be improved in a short period or time. Another object of the invention is to provide an image display capable of providing high-quality, reliable image display by stabilizing the electron emission characteristics and increasing the lifetime thereof.

The image display according to the invention has an opening at least one side of a frame, the size of the opening increasing toward the outside of the display panel, and a frame member whose size is reduced toward the inside of the display panel is fit into the opening. Therefore, the display panel can be easily and uniformly evacuated to a high vacuum level and hence the problems described in the background section can be solved.

The invention provides advantages of providing an opening having a large cross-sectional area, increased conductance of the evacuation system, smooth flow of the inner gas in the display panel without remaining inside, significant improvement in vacuum level in the display panel and the like. Since the frame member is fit into the opening in an airtight manner to form a sealing structure, the assembly tolerance can be relaxed, allowing easy assembly of the display panel. Furthermore, since projections are completely eliminated from the sealed display panel, allowing a thinner display panel, removal of damage potential and an increased degree of freedom of design of the end product. Moreover, reduction in thickness of the display panel provides significantly excellent advantages, such as an increased loading amount of the display panel onto an evacuation cart.

The invention is not limited to the configuration described above and the configurations of examples described below, but various changes can be made thereto without departing from the technical spirit of the invention.

### BRIEF DESCRIPTION OF THE DRAWINGS

FIG. 1 is a plan view of the main portion showing the schematic configuration of the image display according to Example 1 of the image display of the invention;

FIG. 2 is an enlarged cross-sectional view of the main portion taken along the X direction shown in FIG. 1;

FIG. 3A is a plan view of the main portion showing the configuration of the frame shown in FIG. 1;

FIG. 3B is a cross-sectional view taken along the X direction;

FIGS. 4A to 4E are schematic cross-sectional views of a sealing apparatus for explaining a sealing method for forming the frame shown in FIG. 1;

FIGS. 5A to 5C are plan views of the main portion showing the schematic configuration of the frame of the image display according to the invention;

FIG. 6 is a plan view of the main portion showing the configuration of a rear substrate of the image display according to the invention;

FIG. 7 is a plan view of the main portion showing the configuration of a front substrate of the image display according to the invention;

FIG. 8 is an enlarged cross-sectional view of the main portion showing a phosphor surface formed on the front substrate of the image display according to the invention;

FIG. 9 is a plan view of a first substrate that forms the image display according to the invention;

FIG. 10 is a perspective view showing the configuration of the sealed panel of the image display according to the invention;

FIG. 11 is a perspective view showing the configuration of the sealed panel of the image display according to the invention;

FIG. 12 is a perspective view of the image display according to the invention;

FIG. 13 is a perspective view showing the configuration of the frame used in the image display according to the invention; and

FIG. 14 is a perspective view showing the configuration of the frame used in the image display according to the invention.

### DESCRIPTION OF THE PREFERRED EMBODIMENTS

Specific embodiments of the invention will be described below in detail with reference to the drawings of examples.

### Example 1

A representative configuration of the image display of the invention includes an enclosure including a first substrate having electron emission elements formed thereon, a second substrate having a phosphor surface formed thereon and a frame that connects the first substrate to the second substrate such that the substrates face each other and maintain a predetermined height therebetween. At least one of the surface of the frame that faces the first substrate and the surface of the frame that faces the second substrate inclines to the outer surface of the first substrate or the outer surface of the second substrate. The height of the surface of the frame outside the enclosure is higher than the height of the surface of the frame inside the enclosure.

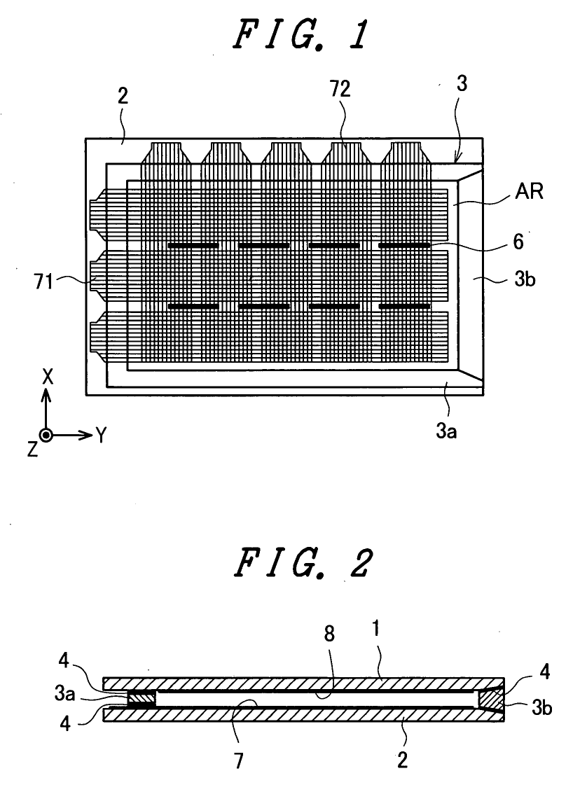

FIG. 1 is a plan view of the main portion for explaining the schematic configuration of the electron emission image display according to Example 1 of the image display of the invention. FIG. 2 is an enlarged cross-sectional view of the main portion taken along the X direction shown in FIG. 1. In FIGS. 1 and 2, reference character 1 denotes a front substrate made of light-transmitting glass plate material, and reference character 2 denotes a rear substrate made of light-transmitting glass plate material as in the front substrate 1 or ceramic plate material, such as alumina. The front substrate 1 and the rear substrate 2 are formed of such insulating substrates having a plate thickness of, for example, about 3 mm.

Reference character 3 denotes a frame obtained by cutting formed material, such as frit glass material and ceramic material, combining and bonding the cut portions into a fixed frame-like structure. The frame 3 is disposed between and at the periphery of the front substrate 1 and the rear substrate 2 using sealing material 4, such as frit glass, to bond and fix the frame 3 between the substrates. The front substrate 1 and the rear substrate 2 are thus held with a gap therebetween having a predetermined dimension, for example, about 3 mm, so as to form a display panel PNL.

In FIG. 1, the frame 3 is formed by combining a U-shaped frame body (first frame) 3a that is formed by integrating the upper and lower sides (two longer sides) and the left side (one shorter side) with a frame member (second frame) 3b such that the remaining open side of the frame body 3a is blocked by the frame member 3b so as to form a closed rectangular frame shape.

On the other hand, the ends of the inner surfaces of the front substrate 1 and the rear substrate 2 that come into contact with the frame member 3b are configured to be inclined surfaces 11 and 21. The inclined surfaces 11 and 21 are configured such that the opening area of the display panel becomes larger toward the periphery of the display panel.

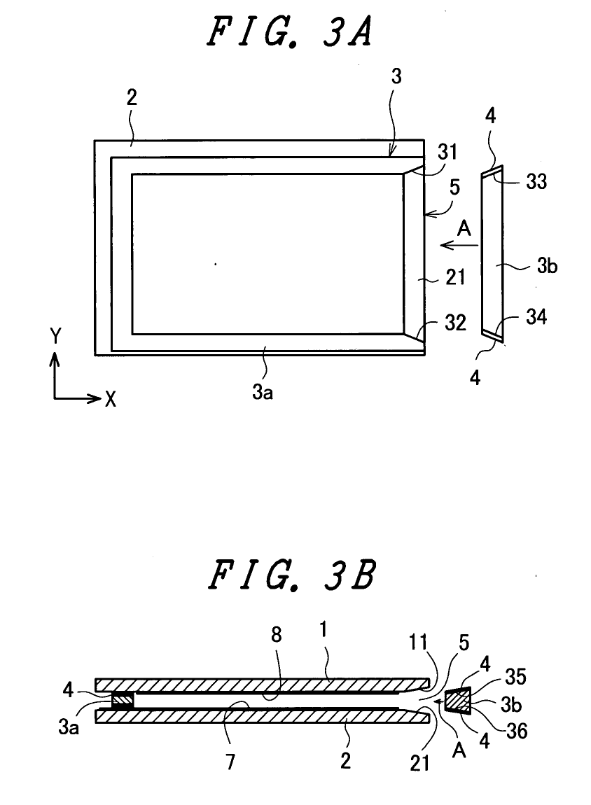

In the frame 3 that has been assembled into a frame shape, the substantially U-shaped frame body 3a having surrounding three sides has the other open side, which forms an opening as an evacuation port, as shown in FIG. 3A, which is a plan view showing the main portion, and FIG. 3B, which is a cross-sectional view taken along the X direction shown in FIG. 3A. The opening 5 is formed such that its opening area becomes larger toward the outside of the frame 3. The opening 5 is formed by providing inclined surfaces 31 and 32 at the end of the frame 3.

Thus, the opening 5 is formed by combining the inclined surface 11 of the front substrate 1, the inclined surface 21 of the rear substrate and the inclined surfaces 31 and 32 of the frame body 3a, so that the opening area becomes gradually larger in the direction toward the outside of the opening 5. The opening 5 is formed at a side having no terminal of each electrode wiring line formed on the rear substrate 2, which will be described later.

The frame member 3b has inclined surfaces 33, 34 and inclined surfaces 35, 36 configured such that the opening area of the opening 5 becomes smaller toward the inside of the opening 5. On the inclined surfaces 33, 34, 35 and 36 of the frame member 3b, the sealing material 4, such as frit glass, is applied, dried and calcined for deposition.

The thus formed frame body 3a and the frame member 3b are placed in a predetermined fixture in a heating furnace and heated at about 350° C. to 400° C. During this process, the display panel is evacuated and the frame member 3b is moved into the opening 5 of the frame body 3a in the direction indicated by the arrow A. Then, the sealing material 4 is melted for fitting the frame member 3b into the opening 5 of the frame body 3a. Thus, each pair of corresponding inclined surfaces is sealed in an airtight manner to form the annular frame 3.

Reference character 6 shown in FIG. 1 denotes a plate-like spacer as a gap retention member. The spacer 6 is formed by cutting a thin glass plate or a ceramic plate, for example, made of alumina, having a thickness of about 0.1 mm or smaller into a piece having a width (to be used as a height dimension) of about 3 mm. The spacer 6 extends in one direction (X-direction) and disposed in a display area AR such that the spacer 6 is substantially perpendicular to the substrate plane. A plurality of the spacers 6 are juxtaposed in the other direction (Y direction) and fixed by fixing material (not shown), such as frit glass. The spacers 6 hold the front substrate 1 and the rear substrate 2 with a gap therebetween having a predetermined dimension in cooperation with the frame 3.

The FPD includes the two substrates, the frame that is responsible for maintaining the gap between the substrates and the plurality of spacers disposed in the display area surrounded by the frame. In an FED panel, since it is necessary to maintain a high vacuum level in the display panel, a plurality of spacers that should withstand a predetermined pressure resulting from the vacuum are required between the substrates (having a gap of about 3 mm). In a display panel of about 32 inch-size, about three spacers of about 100 mm to 110 mm in length are disposed parallel to the longer sides and about six to thirteen columns of the spacers are disposed parallel to the shorter sides. The spacers are disposed and fixed with an interposed gap of about 30 mm in the shorter axis direction.

Reference character 7 denotes a group of electron emission elements. The group of electron emission elements 7 includes a plurality of electron emission sources. Each of the electron emission sources includes a cathode and a control electrode, and a large number of electron emission sources are disposed on the rear substrate 2 at a predetermined interval. The cathode is connected to a cathode wiring line. A plurality of the cathode wiring lines extend on the inner surface of the rear substrate 2 in one direction (Y direction) and are juxtaposed in the other direction (X direction). One end of the cathode wiring line is extended to one side of the rear substrate 2 outside the airtight sealed portion as a cathode wiring extension line 71.

The cathode wiring lines (image data wiring lines) are formed, for example, by using deposition or the like or by printing silver paste obtained by mixing conductive silver particles of about 1 to 5 μm in diameter with low-melting glass that exhibits an insulating property so as to form a thick film, followed by baking, for example, at about 600° C.

The control electrode is connected to a scan wiring line, which is disposed above the cathode wiring line such that the scan wiring line is electrically insulated from the cathode wiring line. One end of the scan wiring line is extended to another side of the rear substrate 2 outside the airtight sealed portion as a scan wiring extension line 72.

The group of electron emission elements 7 disposed on the rear substrate 2 at a predetermined interval are formed of Metal-Insulator-Metal (MIM) electron emission elements, surface conduction electron sources, a diamond film or a graphite film, carbon nanotubes or the like.

Reference character 8 denotes an image forming member. The image forming member 8 includes a phosphor film, a metal-back film deposited on the phosphor film and a black matrix (BM) film. The image forming member 8 is disposed on the inner surface of the front substrate 1 such that the image forming member 8 faces the group of electron emission elements 7 on the rear substrate 2.

While the evacuation port of an conventional panel is formed at the periphery (the area that does not contribute to image display) that surrounds the area where the electron sources are formed, the evacuation port of the panel according to the invention is disposed on a side surface of the panel, allowing an increased image display area without increasing the size of the panel itself. Furthermore, while the conventional evacuation port formed at the periphery of the rear substrate does not allow the size of the evacuation port to be increased, the evacuation port of the panel according to the invention disposed on the side surface of the panel allows the size of the evacuation port to be increased. Therefore, unnecessary gas in the panel can be evacuated in a short period of time.

A method for manufacturing the image display of the invention will now be described.

Firstly, the front substrate and the rear substrate are bonded with the first frame body 3a therebetween so as to form a panel having only one open side that is provided with the inclined surfaces. Then, the side provided with the inclined surfaces is brought into contact with an evacuation duct to evacuate the gas inside the panel from that side.

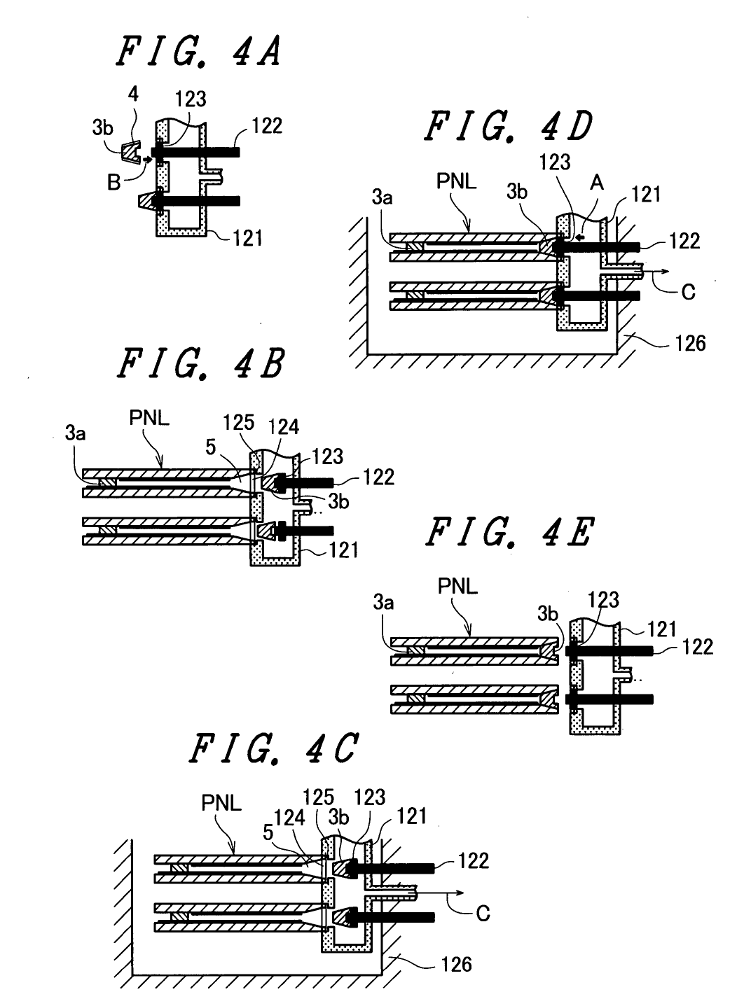

Next, a method for sealing the frame 3 will be described with reference to FIGS. 4A to 4E.

FIGS. 4A to 4E are cross-sectional views of the main portion showing the schematic configuration of a sealing apparatus. Firstly, as shown in FIG. 4A, the frame 3b is mounted on a fixture 123 connected to the front portion of a cylinder 122 in an evacuation chamber 121 in the direction indicated by the arrow B. The fixture 123 on which the frame 3b is mounted uses a mating structure, such as a step joint or a pin joint, in order to prevent a positional shift of the frame 3b.

Then, as shown in FIG. 4B, the opening of the panel is moved such that it abuts the evacuation chamber. The panel is assembled by disposing the substantially U-shaped integral frame body 3a between the front substrate 1 and the rear substrate 2 such that the open side of the frame body 3a forms the opening 5. Then, the opening 5 of the panel PNL is pressed against a vacuum port 124 of the evacuation chamber 121 via a seal member 125, such as an O ring, so as to create a sealed state. The seal member 125 is coupled with a cooling mechanism via cooling means, such as water cooling.

Then, as shown in FIG. 4C, the display panel PNL and the vacuum chamber 121 are placed in a heating furnace 126, heated to about 350° C. to 400° C. and evacuated in the direction indicated by the arrow C using a vacuum pump. When the inside of the panel PNL reaches a predetermined vacuum level, the cylinder 122 presses the mounting fixture 123 in the direction indicated by the arrow A, as shown in FIG. 4D, so as to fit the frame 3b into the opening 5 of the display panel PNL. Thereafter, as shown in FIG. 4E, the display panel PNL is removed, and the evacuation and sealing process is completed. In the thus configured sealing apparatus, a plurality of panels can be placed for one evacuation chamber 121.

The opening 5 formed of the front substrate 1, the rear substrate 2 and the frame body 3a has the inclined surfaces 11, 21 and the inclined surfaces 31, 32 inside the display panel PNL, and the cross-sectional area of the opening 5 increases toward the outside of the display panel PNL. On the other hand, the frame member 3b has the inclined surfaces 33, 34, 35 and 36, and the cross-sectional area of the frame member 3b decreases toward the inside of the opening 5. In this structure, it is extremely easy to compensate for errors associated with the alignment and fitting of the frame member 3b with the opening 5. Therefore, the assembly tolerance of the display panel PNL is relaxed, allowing the evacuation and sealing of the display panel PNL to be extremely easily performed.

The panel according to the invention will not leave any evacuation ducts. Thus, there is no projection (no evacuation duct left on the panel), so that the panel is easily handled and assembled in a monitor set or a television set. Furthermore, the panel according to the invention eliminates the need to chip off the evacuation ducts and hence is easily manufactured.

According to the image display of the invention, since the area of the evacuation port can be increased, the time required for evacuating the panel can be reduced. The panel can be fabricated without providing any evacuation duct on the rear substrate. Furthermore, the inclined upper or lower surface of the frame allows the panel to be easily assembled. Moreover, since the panel can be surrounded by the frame, the gap between the rear substrate and the front substrate can be maintained in a satisfactory manner.

In this example, the first and second substrates have inclined surfaces that face each other, and the second frame has inclined surfaces that face both the first and second substrates. Alternatively, an inclined surface may be formed on one of the first and second substrates and the second frame may have only one inclined surface that faces the inclined surface formed on one of the first and second substrates.

### Example 2

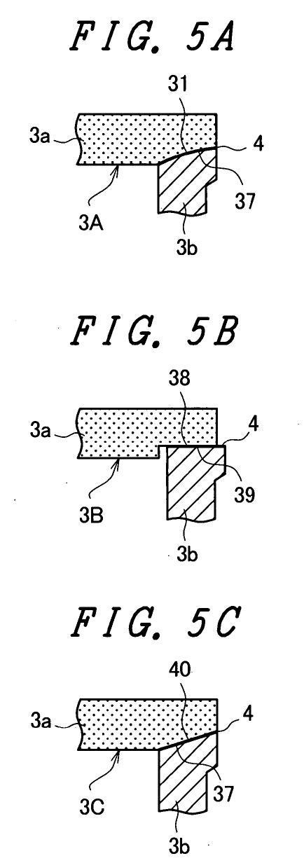

FIGS. 5A to 5C are plan views of the main portion for explaining the schematic configuration of the frame according to Example 2 of the image display of the invention. The same portions in the figures described above have the same reference characters and description thereof will be omitted. In a frame 3A shown in FIG. 5A, the bonding surface of the frame member 3b that mates with the inclined surface 31 of the frame body 3a is a convex surface 37, and the sealing material 4 is applied onto the bonding surface for airtight sealing.

The frame 3B shown in FIG. 5B has a step at the portion where the frame member 3b is bonded to the frame body 3a. The frame body 3a and the frame member 3b are combined such that they mate with each other by means of a step structure and flat surfaces 38 and 39 face each other. The sealing material 4 is interposed between the bonding surfaces, that is, flat surface 38 and the flat surface 39, for airtight sealing. In the frame 3C shown in FIG. 5C, the bonding surfaces where the frame body 3a mate with the frame member 3b are curved structures formed of a concave surface 40 and a convex surface 37, respectively. The sealing material 4 is applied onto the surface where the concave surface 40 and the convex surface 37 are bonded to each other for airtight sealing. These configurations also provide effects substantially similar to that obtained in the above-described example.

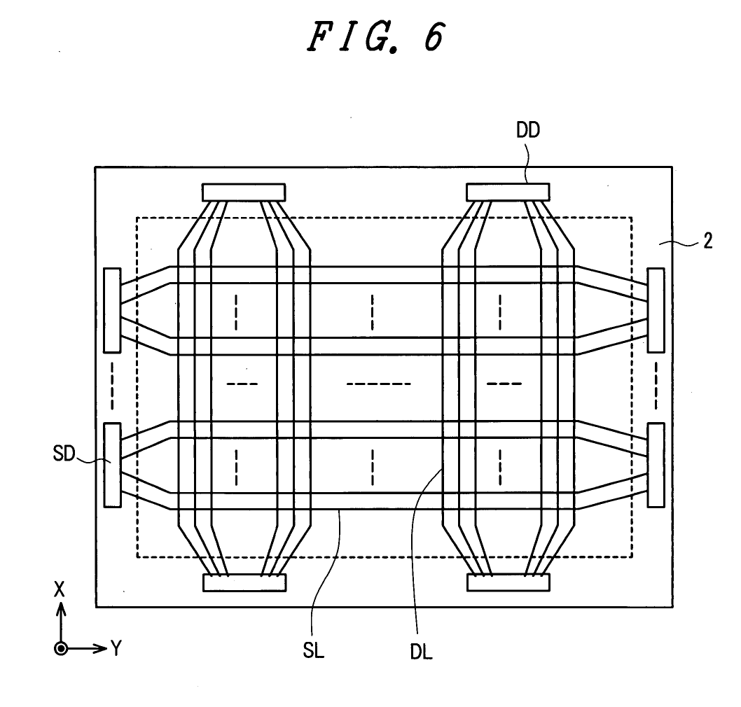

FIG. 6 is a plan view of the main portion viewed from the inner surface side of the rear substrate that forms the image display according to the invention. In FIG. 6, the principal surface (front surface) of the rear substrate 2, for which glass or ceramic material is suitably used, has a plurality of data lines (also referred to as cathode lines) DL that extend in a first direction (Y direction) and are juxtaposed in a second direction (X direction) that crosses the first direction as well as a plurality of scan lines SL that extend in the second direction (X direction) and are juxtaposed in the first direction (Y direction) that crosses the second direction. The electron emission elements are formed at or near the intersections of the data lines DL and the scan lines SL arranged in a matrix.

One end of each of the scan lines SL is connected to a scan driver SD. On the other hand, one end of each of the data lines DL is connected to a data driver DD. The front substrate is disposed along the broken line in the figure and faces the rear substrate. The front substrate 1 and the rear substrate 2 are bonded to each other along the periphery of the area where these substrates face each other and sealed after inner gas is evacuated. The spacers described above are disposed on the scan lines SL.

In FIG. 6, the data drivers DD and the scan drivers SD are disposed on both sides of the display area. In this case, the evacuation may be carried out from an area where no driver is disposed, such as a corner or the area between the drivers.

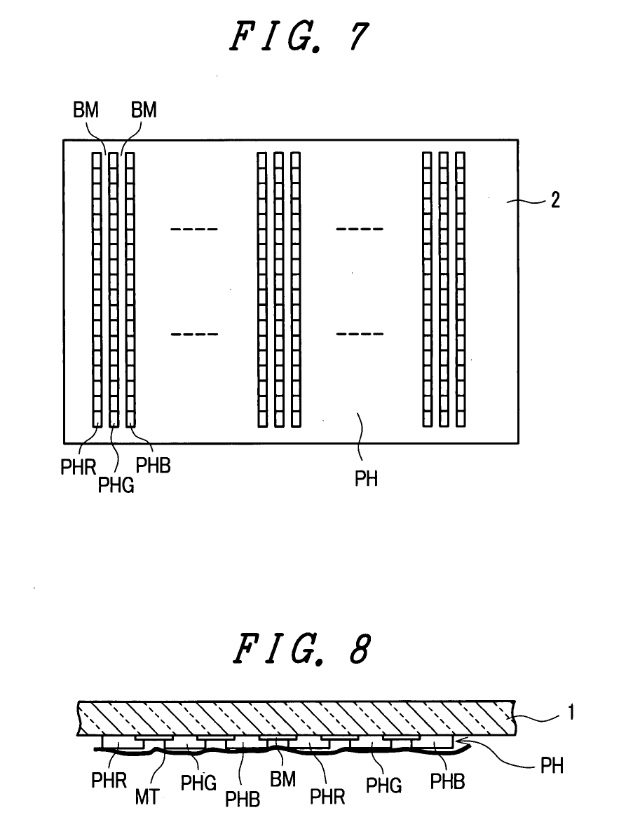

FIG. 7 is a plan view of the main portion viewed from the inner surface side of the front substrate that forms the image display according to the invention. In FIG. 7, on the inner surface of the front substrate 1 made of light transmitting glass material are formed a phosphor surface PH including a red phosphor layer PHR, a green phosphor layer PHG and a blue phosphor layer PHB along the length direction of the plurality of data lines DL shown in FIG. 5. Furthermore, on the phosphor surface PH are formed the black matrix BM that partitions the red phosphor layer PHR, the green phosphor layer PHG and the blue phosphor layer PHB.

FIG. 8 is an enlarged cross-sectional view of the phosphor surface PH formed on the inner surface of the front substrate 1. In FIG. 8, the red phosphor layer PHR, the green phosphor layer PHG and the blue phosphor layer PHB that form the phosphor surface PH are formed such that they cover part of the black matrix BM. On the phosphor surface PH are also formed the metal-back film MT that efficiently reflects light emitting from the red phosphor layer PHR, the green phosphor layer PHG and the blue phosphor layer PHB. An anode voltage is applied to the metal-back film MT, so that the metal-back film MT functions as an anode. The spacers described above are disposed on the black matrix BM.

In the example described above, although the description has been made of the image display that uses the front substrate including the phosphor film and the black matrix film on the inner surface as well as the metal-back film (anode electrode) on the rear side of the phosphor film and the metal-back film, the invention is not limited thereto.

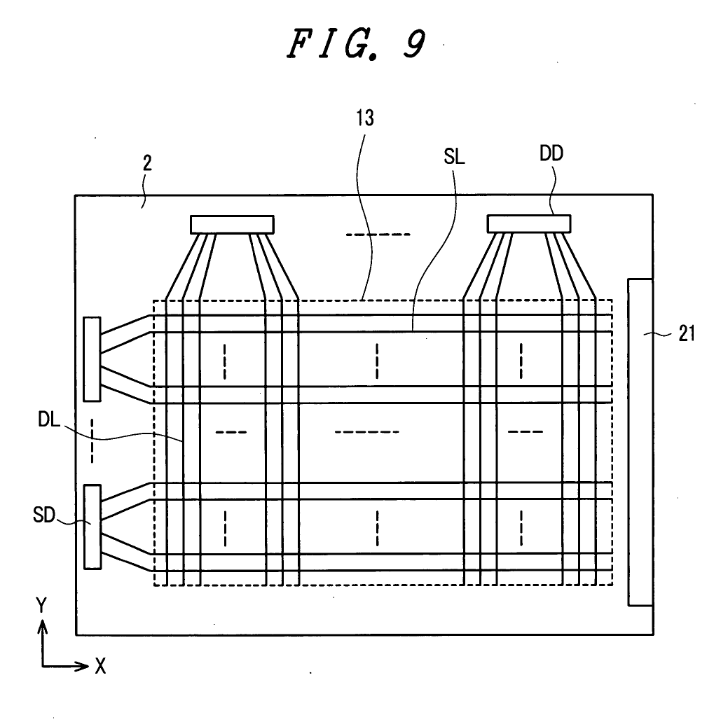

FIG. 9 is a plan view of the first substrate that forms the image display according to the invention.

The principal plane of the first substrate 2 has a plurality of scan wiring lines SL that extend in a first direction (X direction) and are juxtaposed in a second direction (Y-direction) that crosses the first direction as well as a plurality of cathode wiring lines (also referred to as image data wiring lines) DL that extend in the second direction (Y direction) and are juxtaposed in the first direction (X direction) that crosses the second direction. The electron emission elements, which become the electron sources, are formed at the intersections of these lines arranged in a matrix or in the regions surrounded by these wiring lines. The electron emission elements are connected to the respective scan wiring lines SL and image data wiring lines DL. A plurality of electron emission elements are formed in an electron emission area 13.

The scan wiring lines SL are connected to the scan line drive circuit SD and the data wiring lines DL are connected to the data line drive circuit DD. Each of the wiring lines receive data required for image display from each of the drive circuits.

In the image display according to the invention, the first substrate 2 on which the electron sources are formed faces the second substrate on which the phosphor layers are formed. Electrons emitted from the electron sources formed on the first substrate 2 impinge on the phosphor layers formed on the second substrate to cause the phosphors to emit light so as to display an image on the second substrate. Thus, the first substrate 2 does not need to transmit light and hence glass or ceramic material is used for the first substrate 2. Since the second substrate is disposed on the front side of the image display, the second substrate is also referred to as the front substrate, while the first substrate 2 is also referred to as the rear substrate.

The rear substrate 2 has a substantially rectangular outer shape and has the inclined surface 21 along one side thereof. There is an area where no electron emission element is formed around the electron emission area 13. The inclined surface 21 is formed in an area where no electron emission element is formed and along a side where no wiring line is disposed. The evacuation of the panel is carried out from the portion where the inclined surface is formed. Since the evacuation can be carried out from a large area of the side surface of the panel, the evacuation can be completed in a short period of time and the vacuum level can be increased.

### Example 3

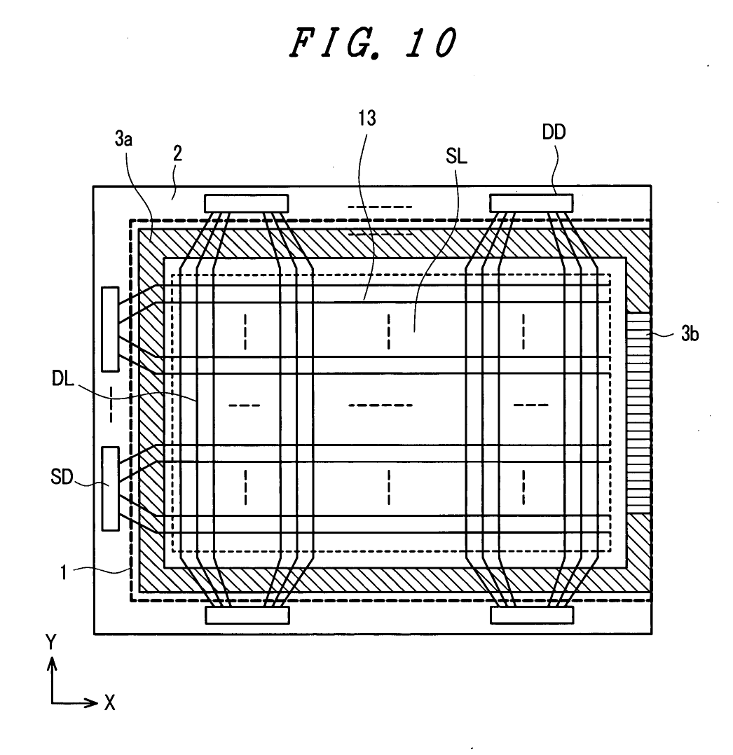

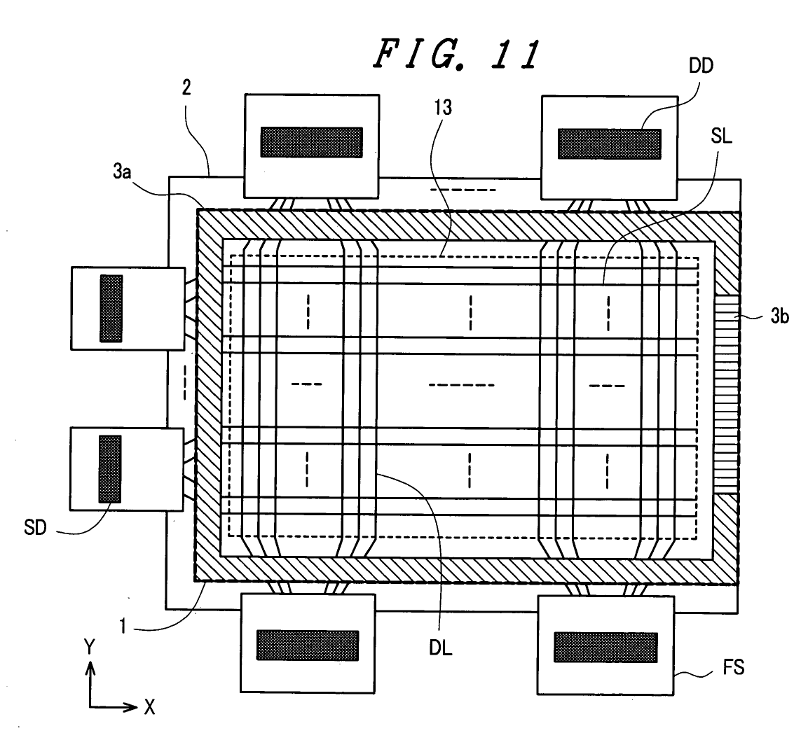

FIGS. 10 and 11 are perspective views showing the configuration of the sealed panel of the image display. The broken line indicates the perimeter of the front substrate 1. The frame 3 is disposed along the perimeter of the area where the front substrate 1 and the rear substrate 2 face each other. The frame 3 is disposed in such a way that it surrounds the rectangular image display area. The front substrate 1 and the rear substrate 2 that are joined with the frame 3 maintain the inside of the panel at a high vacuum level. That is, the panel includes the front substrate 1, the rear substrate 2 and the frame 3 to form a vacuum enclosure. The inclined surfaces of the substrates are formed at part of shorter sides of the rectangularly-arranged frame 3.

The frame 3 includes the first frame 3a that is fixed onto a surface parallel to the inner surface of the front substrate 1 or the rear substrate 2 (the surface on which the phosphor layers are formed or the surface on which data wiring lines and the like are formed) and the second frame 3b that is fixed onto an inclined surface of the substrate. The second frame 3b is disposed on the inclined surface. The second frame 3b is fixed onto the first frame 3a, the front substrate 1 and the rear substrate 2 using frit, which is bonding material. The evacuation is carried out from the portion where the inclined surface is formed.

In the panel shown in FIG. 10, the inclined surface is provided at part of the shorter side, while the surfaces where the first frame 3a and the second frame 3b face each other are not inclined surfaces. In the panel shown in FIG. 10, the scan line drive circuits SD and the data line drive circuits DD are directly disposed on the rear substrate 2.

In the panel shown in FIG. 11, not only is an inclined surface provided at part of the shorter side but also the surfaces where the first frame 3a and the second frame 3b face each other are inclined surfaces. Since the first frame 3a, the second frame 3b and the rear substrate 2 have inclined surfaces, it is easy to align these members. In the panel shown in FIG. 11, flexible substrates FS, each of which has the scan line drive circuit SD or the data line drive circuit DD disposed thereon, are connected to the rear substrate 2.

The panel may be configured such that an inclined surface is formed on the portion of the front substrate 1 that faces the inclined surface 21 formed on the rear substrate 2. Inclined surfaces formed on both the front substrate 1 and the rear substrate 2 allow the second frame 3b to be easily inserted, so that the panel is easily manufactured.

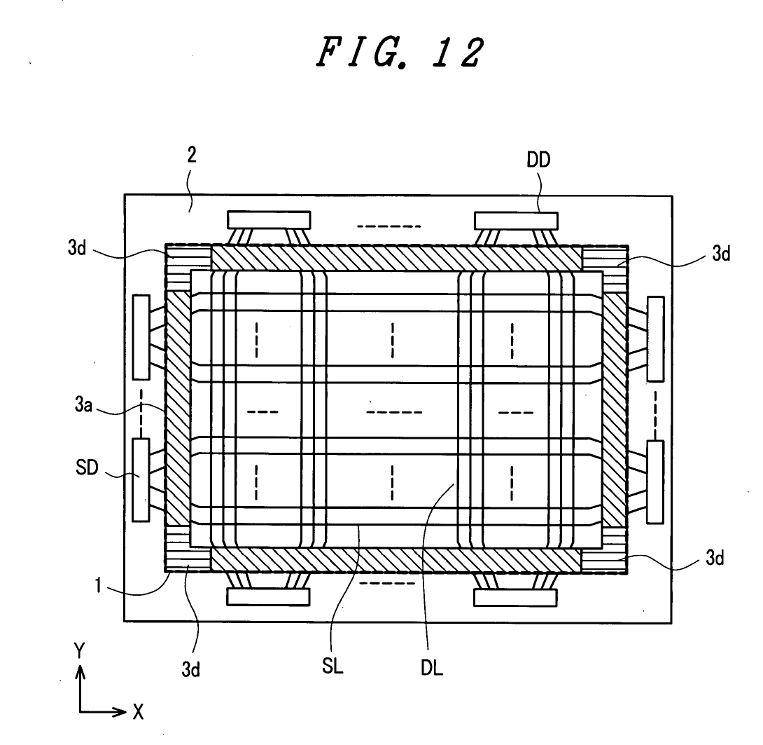

FIG. 12 is a perspective view of an image display having drive circuits disposed on both ends of the scan wiring lines SL and the cathode wiring lines DL. In this case, inclined portions may be provided on a third frame 3d that is situated at each corner of the front substrate 1 and the rear substrate 2. The data line drive circuits DD and the scan line drive circuits SD may be directly disposed on the rear substrate 2 and connected to the wiring lines, or may be connected to the wiring lines via the flexible substrates FS.

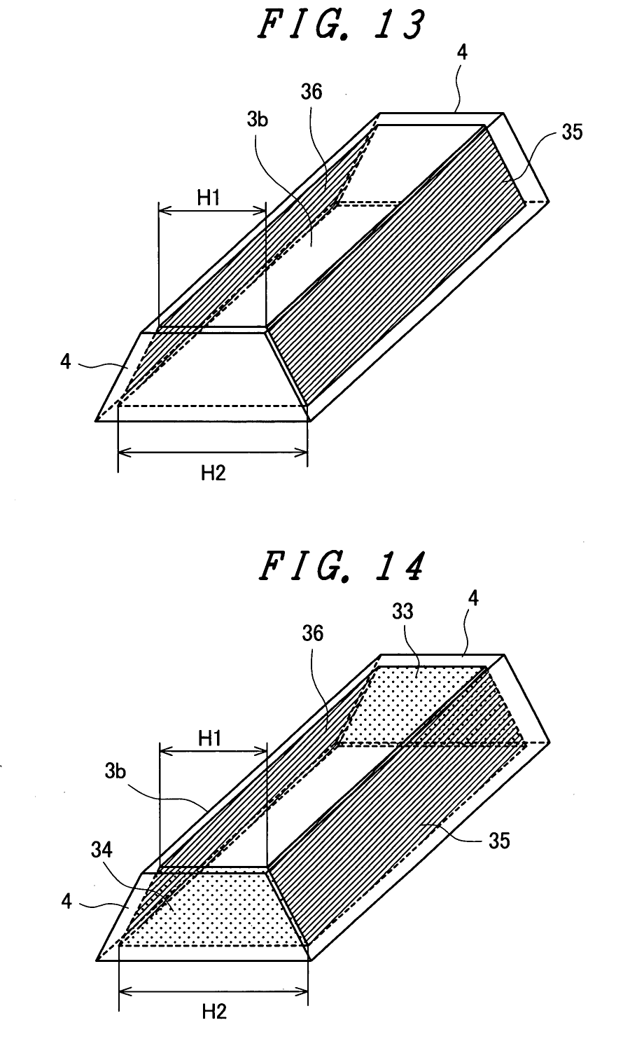

FIGS. 13 and 14 are perspective views showing the configuration of the second frame 3b. The second frame 3b has an inclined surface that inclines to the surface on which the scan wiring lines and the data wiring lines are formed or an inclined surface that inclines to the surface on which the phosphor layers are formed. The second frame 3b is configured such that the height H2 of the surface of the frame disposed outside the enclosure is higher than the height H1 of the surface of the frame disposed inside the enclosure. A trapezoidal shape in which the height H2 of the surface of the second frame 3b outside the enclosure is higher than the height H1 of the surface of the second frame 3b inside the enclosure prevents the second frame 3b to be shifted inside the vacuum enclosure.

The second frame 3b shown in FIG. 13 is used in the panel shown in FIG. 10, while the second frame 3b shown in FIG. 14 is used in the panel shown in FIG. 1 or 11. The inclination of each of the inclined surfaces 35 and 36 is designed such that the inclined surfaces 35 and 36 mate with the inclined surfaces of the front substrate and the rear substrate. In the second frame 3b shown in FIG. 14, the surfaces that face the first frame 3a are also inclined surfaces 33 and 34. The sealing material 4, such as frit glass, is applied to the side surfaces of the second frame 3b. In this case, the sealing material 4 is dried. Since the panel according to the invention has no evacuation duct, occurrence of cracks in the panel can be suppressed.

What is claimed is:

1. An image display including a display panel having an enclosure comprising:
a front substrate having a phosphor layer and an anode electrode;
a rear substrate that has electron sources and faces the front substrate with a predetermined gap therebetween; and
a frame disposed around a display area and between the front substrate and the rear substrate,
wherein the display panel has an opening configured such that the distance between the front substrate and the rear substrate increases toward the periphery of the display panel, and a frame member whose height decreases toward the inside of the display panel is fit into the opening for airtight sealing.

2. The image display according to claim 1, wherein the coefficient of thermal expansion of the frame member is substantially equal to or smaller than the coefficient of thermal expansion of the display panel.

3. The image display according to claim 2, wherein the frame member is made of glass material.

4. The image display according to claim 2, wherein the frame member is made of ceramic material.

5. The image display according to claim 2, wherein the opening is sealed in an airtight manner by the frame member with sealing material interposed between the frame member and the opening.

6. The image display according to claim 1, wherein the rear substrate includes
a plurality of scan signal electrodes that extend in one direction and are juxtaposed in another direction perpendicular to the one direction, scan signals successively applied to the plurality of scan signal electrodes in the other direction
a plurality of image signal electrodes that extend in the other direction and are juxtaposed in the one direction such that the image signal electrodes cross the scan signal electrodes
electron sources provided at intersections of the scan signal electrodes and the image signal electrodes and
feeding electrodes that connect the electron sources to the scan signal electrodes and the image signal electrodes, and
the opening is provided at a side of the display panel where electrode extensions of the scan signal electrodes and the image signal electrodes are not formed.

7. An image display comprising an enclosure comprising a first substrate on which electron emission elements are formed, a second substrate on which a phosphor surface is formed and a frame that connects the first substrate to the second substrate, the enclosure being evacuated,
wherein the first substrate includes a plurality of scan lines that extend in a first direction and are arranged in a second direction that crosses the first direction as well as a plurality of data lines that extend in the second direction and are arranged in the first direction, first electrodes connected to the scan lines and second electrodes connected to the data lines forming the electron emission elements, and
at least one of the surface of the frame that faces the first substrate and the surface of the frame that faces the second substrate is an inclined surface that inclines to the plane formed by the first and second directions, the height of the surface of the frame disposed outside the enclosure being higher than the height of the surface of the frame disposed inside the enclosure.

8. The image display according to claim 7, wherein the inclined surface is provided on the surface that faces the first substrate and the surface that faces the second substrate.

9. The image display according to claim 7, wherein the frame has a rectangular shape and the inclined surface is formed at a side of the rectangular frame.

10. The image display according to claim 7, wherein the portion of the first substrate or the second substrate that faces the inclined surface is an inclined surface.
